(19) United States
(12) Patent Application Publication
(10) Pub. No.: US 2007/0218334 A1
(43) Pub. Date: Sep. 20, 2007

(54) Methods for making sulfonated non-aromatic polymer electrolyte membranes

(76) Inventor: Lukas M. Bonorand, Coquitlam (CA)

Correspondence Address: SEED INTELLECTUAL PROPERTY LAW GROUP PLLC, 701 FIFTH AVE, SUITE 5400, SEATTLE, WA, 98104, US

(21) Appl. No.: 11/377,901

(22) Filed: Mar. 16, 2006

(51) Int. Cl. H01M 8/10; C08J 5/22

(52) U.S. Cl. 429/33; 521/27

(57) ABSTRACT

A method for making a sulfonated polymer electrolyte membrane for use in an electrochemical fuel cell is disclosed, the method comprising sulfonating a non-aromatic polymer membrane material, wherein the membrane material is not irradiated prior to sulfonation. A sulfonated polymer electrolyte membrane for use in an electrochemical fuel cell produced according to the foregoing method and an electrochemical fuel cell comprising such a sulfonated polymer electrolyte membrane are also disclosed.

### CROSS-REFERENCE TO RELATED APPLICATION

This application claims the benefit under 35 U.S.C. §119(e) of U.S. Provisional Patent Application No. ______ filed Oct. 4, 2005 (formerly U.S. patent application Ser. No. 11/243,455, converted by petition under 37 CFR 1.53(c)(2) on Mar. 15, 2006 via Express Mail No. EV741780282US), the disclosure of which is incorporated herein by reference in its entirety.

### BACKGROUND OF THE INVENTION

1. Field of the Invention

The present invention relates generally to electrochemical fuel cells, and, more particularly, to methods for making sulfonated non-aromatic polymer electrolyte membranes for use in electrochemical fuel cells.

2. Description of the Related Art

Electrochemical fuel cells convert reactants, namely fuel and oxidant fluid streams, to generate electric power and reaction products. Electrochemical fuel cells generally employ an electrolyte disposed between two electrodes, namely a cathode and an anode. An electrocatalyst, disposed at the interfaces between the electrolyte and the electrodes, typically induces the desired electrochemical reactions at the electrodes. The location of the electrocatalyst generally defines the electrochemically active area.

One type of electrochemical fuel cell is the polymer electrolyte membrane (PEM) fuel cell. PEM fuel cells generally employ a membrane electrode assembly (MEA) comprising a solid polymer electrolyte, or ion-exchange, membrane disposed between two electrodes. Each electrode typically comprises a porous, electrically conductive substrate, such as carbon fiber paper or carbon cloth, which provides structural support to the membrane and serves as a fluid diffusion layer. The membrane is ion conductive (typically proton conductive), and acts both as a barrier for isolating the reactant streams from each other and as an electrical insulator between the two electrodes. The electrocatalyst is typically a precious metal composition (e.g., platinum metal black or an alloy thereof) and may be provided on a suitable support (e.g., fine platinum particles supported on a carbon black support).

In a fuel cell, a MEA is typically interposed between two separator plates that are substantially impermeable to the reactant fluid streams. The plates typically act as current collectors and provide support for the MEA. In addition, the plates may have reactant channels formed therein and act as flow field plates providing access for the reactant fluid streams to the respective porous electrodes and providing for the removal of reaction products formed during operation of the fuel cell.

In a fuel cell stack, a plurality of fuel cells are connected together, typically in series, to increase the overall output power of the assembly. In such an arrangement, one side of a given separator plate may serve as an anode flow field plate for one cell and the other side of the plate may serve as the cathode flow field plate for the adjacent cell. In this arrangement, the plates may be referred to as bipolar plates. Typically, a plurality of inlet ports, supply manifolds, exhaust manifolds and outlet ports are utilized to direct the reactant fluid to the reactant channels in the flow field plates. The supply and exhaust manifolds may be internal manifolds, which extend through aligned openings formed in the flow field plates and MEAs, or may comprise external or edge manifolds, attached to the edges of the flow field plates.

A broad range of reactants can be used in PEM fuel cells. For example, the fuel stream may be substantially pure hydrogen gas, a gaseous hydrogen-containing reformate stream, or methanol in a direct methanol fuel cell. The oxidant may be, for example, substantially pure oxygen or a dilute oxygen stream such as air.

During normal operation of a PEM fuel cell, fuel is electrochemically oxidized on the anode side, typically resulting in the generation of protons, electrons, and possibly other species depending on the fuel employed. The protons are conducted from the reaction sites at which they are generated, through the membrane, to electrochemically react with the oxidant on the cathode side. The electrons travel through an external circuit providing useable power and then react with the protons and oxidant on the cathode side to generate water reaction product.

In a typical PEM fuel cell, the membrane comprises a solid polymer material and an electrolyte group such as a sulfonic acid group or a carboxylic acid group in the polymer chain. Desirable characteristics of a PEM include good mechanical strength, high conductivity, resistance to oxidative and thermal degradation, and dimensional stability upon hydration and dehydration. A variety of membranes have been developed over the years for application as solid polymer electrolytes for fuel cells and other electrochemical applications with these characteristics in mind. These membranes have typically been perfluorinated-based compositions, such as those described in U.S. Pat. Nos. 3,282,875 and 4,330,654. However, perfluorinated-based compositions are very expensive membranes, and, in the case of the '875 patent, tend to exhibit poor fuel cell performance characteristics at high current densities.

Alternatively, a series of lower-cost polyaromatic-based membranes have been investigated, such as those described in U.S. Pat. No. 5,679,482, U.S. Patent Application Publication No. 2004/0214065 and Japanese Patent Application Publication No. 2004-315723. Although hydrocarbon-based materials are considerably less expensive than the typical perfluorinated materials, membranes produced from polyaromatic-based materials suffer from poor chemical resistance and mechanical properties which tend to limit their use in fuel cell applications.

More recently, various non-aromatic-based membranes have been investigated, as described in U.S. Pat. Nos. 6,630,518 and 6,902,849. The chemical resistance of these non-aromatic materials are superior to the foregoing polyaromatic-based materials due to the lack of aromatic groups which are susceptible to desulfonation and chemical degradation. However, the methods for producing a polymer electrolyte membrane from non-aromatic hydrocarbon-based materials require that the membrane material be irradiated prior to sulfonation. Unfortunately, incorporating such a pre-irradiation step adversely increases both the cost and complexity of the manufacturing process.

Accordingly, although there have been advances in the field, there remains a need in the art for improved polymer electrolyte membranes with favorable chemical and mechanical properties, and methods of producing such membranes in high yield and low cost. The present invention addresses these needs and provides further related advantages.

### BRIEF SUMMARY OF THE INVENTION

In brief, the present invention relates to methods for making sulfonated non-aromatic polymer electrolyte membranes for use in electrochemical fuel cells.

In one embodiment, a method for making a sulfonated polymer electrolyte membrane for use in an electrochemical fuel cell is disclosed, the method comprising sulfonating a non-aromatic polymer membrane material, wherein the membrane material is not irradiated prior to sulfonation.

In a further embodiment of the foregoing method, the step of sulfonating the membrane material comprises immersing the membrane material in a solution comprising sulfur trioxide.

In another further embodiment, the foregoing method further comprises impregnating the membrane material with an additive following the step of sulfonating the membrane material, wherein the additive is selected from the group consisting of antioxidants, proton conductive additives and water retention additives.

In yet another further embodiment, the foregoing method further comprises fluorinating the membrane material following the step of sulfonating the membrane material.

In yet another further embodiment, the foregoing method further comprises densifying the membrane material following the step of sulfonating the membrane material. In a more specific embodiment, the step of densifying the membrane material comprises exposing the membrane material to elevated heat and pressure.

In yet another further embodiment of the foregoing method, the membrane material comprises ultra-high molecular weight polyethylene.

In a second embodiment, a sulfonated polymer electrolyte membrane for use in an electrochemical fuel cell produced according to the foregoing method is disclosed.

In a third embodiment, an electrochemical fuel cell comprising a sulfonated polymer electrolyte membrane produced according to the foregoing method is disclosed.

These and other aspects of the invention will be evident upon reference to the following detailed description and attached drawing.

### BRIEF DESCRIPTION OF THE DRAWING

FIG. 1 shows polarization curves for an MEA comprising a membrane made by the method of the present invention after 0 and 500 hours of continuous operation.

### DETAILED DESCRIPTION OF THE INVENTION

In the following description, certain specific details are set forth in order to provide a thorough understanding of various embodiments of the invention. However, one skilled in the art will understand that the invention may be practiced without these details. In other instances, well-known structures associated with fuel cells, fuel cell stacks, fuel cell systems have not been shown or described in detail to avoid unnecessarily obscuring descriptions of the embodiments of the invention.

Unless the context requires otherwise, throughout the specification and claims which follow, the word “comprise” and variations thereof, such as, “comprises” and “comprising” are to be construed in an open, inclusive sense, that is as “including, but not limited to”.

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As discussed above, a variety of polymer membrane materials have been developed over the years for use as solid polymer electrolytes for fuel cells and in other electrochemical applications. However, in PEM development efforts to date it has been necessary to compromise between achieving (i) the desired mechanical and chemical properties, and (ii) controlling manufacturing costs and complexity. Accordingly, there remains a need in the art for improved polymer electrolyte membranes with favorable chemical and mechanical properties, and methods of producing such membranes in high yield and low cost.

The present invention addresses the foregoing needs by providing methods for making sulfonated non-aromatic polymer electrolyte membranes for use in electrochemical fuel cells. Contrary to the teachings of the prior art, namely, U.S. Pat. Nos. 6,630,518 and 6,902,849, it has been discovered that a hydrocarbon-based non-aromatic polymer membrane material may be sulfonated directly, without a pre-irradiation step.

Such a direct sulfonation process is very simple and cost effective. The necessary equipment merely comprises a sulfonation reactor (either gas-phase or solution sulfonation) and a conditioning bath, and the necessary materials merely comprise a hydrocarbon-based non-aromatic polymer membrane material and a sulfonating agent, all of which are relatively low cost components.

Polymer Membrane Materials

As used herein, the term “non-aromatic” means that the polymer membrane material does not comprise homocyclic or heterocyclic aromatic units or groups, such as phenyl, naphthyl or pyridinyl. Suitable non-aromatic polymer membrane materials include hydrocarbons, such as, for example, polyolefins. Examples of suitable polyolefins include polyethylene, including ultra-high molecular weight polyethylene (UHMWPE), and polypropylene.

It has been found that the use of an ultra-high molecular weight material, such as UHMWPE, imparts superior mechanical strength to the resulting membrane, as well as increased robustness and durability against chemical attack and dissolution in comparison to typical regular molecular weight materials. As used herein, the term “ultra-high molecular weight” refers to polymers having molecular weights on the order of several million, typically between 3.1 and 5.67 million, and 100,000 to 250,000 monomers per molecule. This is several orders of magnitude larger than familiar materials such as high density polyethylene which typically has 700 to 1,800 monomers per molecule.

While the inventors do not wish to be bound by any particular theory, it is believed that the high molecular weight results in a high degree of chain entanglement and produces a very tough, impact resistant material. These characteristics are beneficial for durability in fuel cells due to the ability to withstand internal stresses in the membrane that develop during expansion and contraction due to changes in hydration levels. The high molecular weight is also advantageous with respect to chain scission that occurs in the polymer electrolyte membrane during fuel cell operation. For example, a ultra-high molecular weight polymer with 250,000 repeating units can break down into 250 segments and still have the properties of a regular high density polyethylene polymer with 1,000 repeating units. Accordingly, for the foregoing reasons, the lifetime of a UHMW-based membrane can be expected to be superior to that of another material with comparable chemical susceptibility.

Furthermore, it is believed that the use of non-aromatic polymer membrane materials is superior with respect to both chemical and mechanical properties, as well as ease of processing. With respect to chemical robustness, aromatic-based membrane materials are highly susceptible to hydroxylation by the hydroxyl radicals present during fuel cell operation. Accordingly, the use of non-aromatic materials renders the resulting membrane more resistant to degradation. With respect to mechanical properties, aromatic-based materials are generally rigid due to their high degree of steric hindrance. Therefore, during hydration/dehydration cycles in an operating fuel cell, there is a lack of stress relaxation. Non-aromatic materials, however, provide much better plasticity and can relax the internal stresses, leading to improved durability and mechanical robustness. With respect to ease of processing, many aromatic-based membranes require additional processing steps to introduce the aromatic units or groups into the hydrocarbon-based starting material. Accordingly, by utilizing non-aromatic materials such additional steps may be eliminated. Furthermore, due to their rigidity, most aromatic-based materials are difficult to form into a thin and flexible film (when making films of less than 100 microns thickness), with the exception of polyesters, polyethers, polyurethanes, and polyamides which comprise condensation-type functionalities prone to hydrolysis in acidic environments.

Sulfonating Agents and Conditions

The foregoing non-aromatic polymer membrane materials may be sulfonated by using a conventional sulfonating agent such as, for example, sulfur trioxide, sulfuric anhydride, fuming sulfuric acid, chlorosulfonic acid, sulfuric acid, or sodium hydrogensulfite under known conditions (see Polymer Preprints, Japan, Vol. 42, No. 3, p. 730 (1993); Polymer Preprints, Japan, Vol. 42, No. 3, p. 736 (1994); and Polymer Preprints, Japan, Vol. 42, No. 7, pp. 2490-2492 (1993)). More specifically, the membrane material may be caused to react with a sulfonating agent in the presence or absence of a solvent. As the solvent, hydrocarbon solvents, ether solvents such as tetrahydrofuran and dioxane, polar aprotic solvents such as dimethylacetamide, dimethylformamide, and dimethylsulfoxide, halogenated hydrocarbons such as tetrachloroethane, dichloroethane, chloroform, and methylene chloride, and the like can be given.

It has been found that by using a strong sulfonating agent such as sulfur trioxide, the sulfonation rate of the method of the present invention is comparable to the sulfonation rate of the methods comprising a pre-irradiation step. Accordingly, the present invention provides a method for sulfonating a hydrocarbon-based non-aromatic polymer membrane material directly, without a pre-irradiation step. Eliminating the need for such a pre-irradiation step provides a significant reduction in manufacturing and processing costs due to the relatively high cost of irradiation equipment in comparison to the low cost of membrane materials and sulfonation equipment.

Additives

If desired, the non-aromatic polymer membrane material may be impregnated with an additive following the step of sulfonating the membrane material to enhance one or more characteristics of the membrane. A representative impregnation process is set forth in U.S. Patent Application Publication No. 2003/0059657, the disclosure of which is incorporated herein by reference.

Representative additives which may be desirable to impregnate into the polymer membrane material include antioxidants, proton conductive additives and water retention additives. Although suitable additives will be apparent to persons of ordinary skill in the art, the following examples are provided for purposes of illustration. Examples of antioxidants include transition metal oxides, radical scavengers and metal sequestering agents, such as but not limited to manganese oxides, iron oxides, titanium oxides, cobalt oxides, tungsten oxides, ruthenium oxides, vanadium oxides, palladium oxides, and chromium oxides. Examples of proton conductive additives include phosphoric acid, phosphonic acid and ionic liquids, such as imidazoles and triazoles. Examples of water retention additives include hydrophilic materials, silica acid, zeolites, caged materials and fullerenes, such as but not limited to hydrogels, SiO₂, TiO₂, ZrO₂, and combinations thereof.

Fluorinating Agents and Conditions

If desired, the non-aromatic polymer membrane material may be fluorinated following the step of sulfonating the membrane material to enhance one or more characteristics of the membrane, such as the oxidative stability thereof. Fluorination of the membrane material may be accomplished by any of a variety of known techniques. For example, the membrane material may be contacted with fluorine gas, typically diluted with an inert gas and, optionally, with a small amount of other gases such as carbon dioxide to manipulate the surface of the substrate, at room temperature (see, e.g., Lagow and Margrave, “The Controlled Reaction of Hydrocarbon Polymers with Elemental Fluorine”, Polymer Letters Edition, Publ. John Wiley & Sons, Vol. 12, pp 177-184, 1974). Again, any number of fluorination techniques may be utilized, which techniques are well known to those skilled in this field.

Densification Conditions

If desired, the non-aromatic polymer membrane material may be densified following the step of sulfonating the membrane material to make the membrane fluid impermeable. More specifically, the membrane material may be densified by exposing the membrane material to elevated heat and pressure. For example, the membrane may be subjected to temperatures between about 100° C. and about 200° C., such as between about 140° C. and about 160° C. Additionally, or alternatively, the membrane may be subjected to pressure between about 10 bar and about 200 bar, such as between about 20 bar and about 50 bar.

The membrane material may be densified directly following sulfonation or, optionally, the sulfonated membrane material may first undergo an ion exchange process with a concentrated salt solution (comprising, for example, sodium, potassium or cesium ions) to obtain better temperature resistance and better melt flow characteristics. In one example, the membrane may be densified directly during bonding into an MEA, instead of separately densifying and then bonding the MEA, thereby eliminating a processing step.

Other Post Processing Options

In addition, if desired, the non-aromatic polymer membrane material may be annealed or irradiated to improve its mechanical strength.

### EXAMPLES

### Example 1

A microporous polyethylene (PE) film containing ultra high molecular weight polyethylene (UHMWPE) (Solupor® 3P07A, DSM Solutech) was cut into 5×5 cm sized pieces. The sulfonation mixture was prepared by adding 12 mL of SO₃ (ACROS) to 28 mL of 1,2-dichloroethane (DCE) (Sigma) at room temperature under stirring. This resulted in a 30% (by volume) solution of SO₃ in DCE. The precut PE sample was added to the sulfonation mixture (40 mL) at room temperature (RT) and the reaction was then conducted at room temperature for 15 min without any agitation. The sample was then removed from the sulfonation mixture and put into deionized water. After 2 hrs soaking in deionized water, the sample was rinsed three times and soaked for an additional 15 min in deionized water to remove all excess sulfuric acid. The equivalent weight (EW) analysis resulted in 417 g/mol, which corresponds to an ion exchange capacity (IEC) of 2.40 mmol/g.

### Example 2

A microporous PE file containing UHMWPE (Solupor® 3P07A, DSM Solutech) was cut into 5×5 cm sized pieces. The sulfonation mixture was prepared by adding 4 mL of SO₃ (ACROS) to 36 mL of DCE (Sigma) at room temperature under stirring. This resulted in a 10% (by volume) solution of SO₃ in DCE. The precut PE sample was added to the sulfonation mixture (40 mL) at RT and the reaction was then conducted at 50° C. for 30 min without any agitation. The sample was then removed from the sulfonation mixture and put into deionized water. After 2 hrs soaking in deionized water, the sample was rinsed three times and soaked for an additional 15 min in deionized water to remove all excess sulfuric acid. The EW analysis resulted in 447 g/mol, which corresponds to an IEC of 2.24 mmol/g.

### Example 3

A microporous PE film containing UHMWPE (Solupor® 3P07A, DSM Solutech) was cut into 5×5 cm sized pieces. The sulfonation mixture was prepared by adding 2 mL of SO₃ (ACROS) to 38 mL of DCE (Sigma) at room temperature under stirring. This resulted in a 5% (by volume) solution of SO₃ in DCE. The precut PE sample was added to the sulfonation mixture (40 mL) at RT and the reaction was then conducted at 50° C. for 60 min without any agitation. The sample was then removed from the sulfonation mixture and put into deionized water. After 2 hrs soaking in deionized water, the sample was rinsed three times and soaked for an additional 15 min in deionized water to remove all excess sulfuric acid. The EW analysis resulted in 488 g/mol, which corresponds to an IEC of 2.05 mmol/g.

### Example 4

A microporous PE film containing UHMWPE (Solupor® 3P07A, DSM Solutech) was cut into a 200×20 cm sized piece. The sulfonation mixture was prepared by adding 400 mL of SO₃ (ACROS) to 1600 mL of DCE (Sigma) at room temperature under stirring. This resulted in a 20% (by volume) solution of SO₃ in DCE. The precut PE sample was added to the sulfonation mixture (2 L) at RT and the reaction was then conducted at room temperature for 15 min without any agitation. The sample was then removed from the sulfonation mixture and put into deionized water. After soaking in deionized water over night, the sample was rinsed three times and soaked for an additional 30 min in deionized water to remove all excess sulfuric acid. The EW analysis resulted in 587 g/mol, which corresponds to an IEC of 1.70 mmol/g.

### Example 5

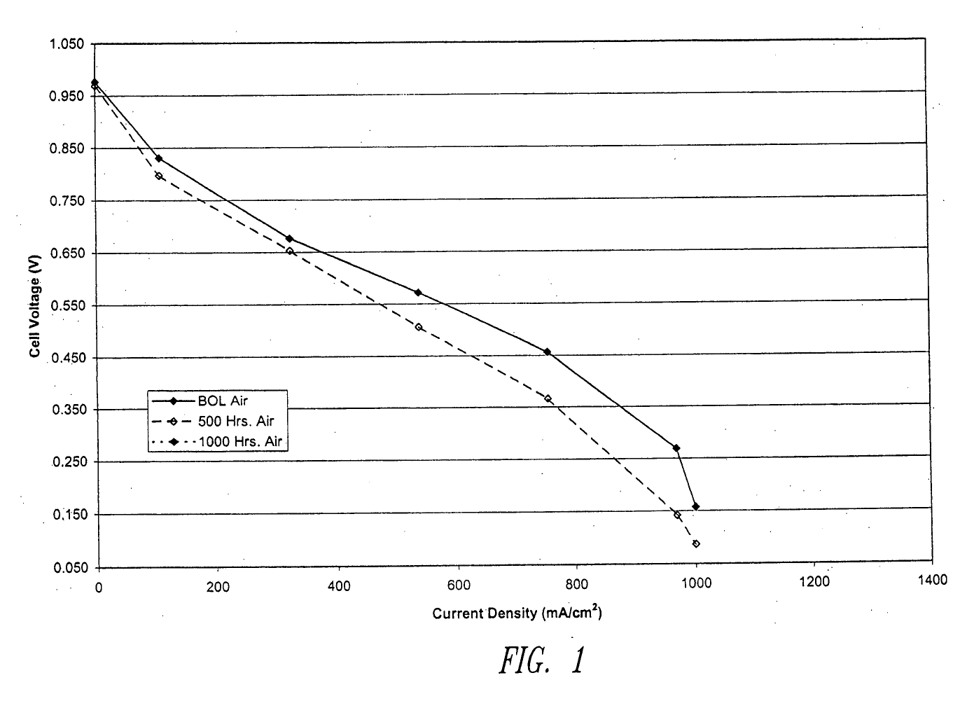

A 10×10 cm piece of the sulfonated membrane prepared according to Example 4 was soaked in deionized water over night. The hydrated membrane was then bonded to electrodes at 140° C. for 2 min at 20 bar to form an MEA. A controlled cooling period of 5 min followed. The resulting MEA was tested as a single cell and operated under the following conditions: Oxid/H₂ pressure: 30/30 psig; Oxid/H₂ stoich: 2.0/1.5; and temperature: 80° C. FIG. 1 shows polarization curves for the resulting MEA at the beginning of operation and after 500 hours of operation. As shown, the MEA is operable and stable after 500 hours of continuous operation using the membrane made by the low-cost and simplified method of the present invention.

### Example 6

A sulfonated membrane prepared according to Example 4 is fluorinated by placing it in a sealed reactor containing 5-25% fluorine and the balance nitrogen. The sample is treated for 25 minutes to 24 hours at ambient temperature and pressure to fluorinate the sample.

All of the U.S. patents, U.S. patent application publications, U.S. patent applications, foreign patents, foreign patent applications and non-patent publications referred to in this specification and/or listed in the Application Data Sheet, are incorporated herein by reference, in their entirety to the extent not inconsistent herewith. Aspects of the invention can be modified, if necessary, to employ aspects of such patents, applications and publications to provide yet further embodiments of the invention.

While particular steps, elements, embodiments and applications of the present invention have been shown and described herein for purposes of illustration, it will be understood, of course, that the invention is not limited thereto since modifications may be made by persons skilled in the art, particularly in light of the foregoing teachings, without deviating from the spirit and scope of the invention. Accordingly, the invention is not limited except as by the appended claims.

What is claimed is:

1. A method for making a sulfonated polymer electrolyte membrane for use in an electrochemical fuel cell, the method comprising:
sulfonating a non-aromatic polymer membrane material,
wherein the membrane material is not irradiated prior to sulfonation.

2. The method of claim 1 wherein the step of sulfonating the membrane material comprises immersing the membrane material in a solution comprising sulfur trioxide.

3. The method of claim 1 further comprising:
impregnating the membrane material with an additive following the step of sulfonating the membrane material,
wherein the additive is selected from the group consisting of antioxidants, proton conductive additives and water retention additives.

4. The method of claim 1 further comprising:
fluorinating the membrane material following the step of sulfonating the membrane material.

5. The method of claim 1 further comprising:
densifying the membrane material following the step of sulfonating the membrane material.

6. The method of claim 5 wherein the step of densifying the membrane material comprises exposing the membrane material to elevated heat and pressure.

7. The method of claim 1 wherein the membrane material comprises ultra-high molecular weight polyethylene.

8. A sulfonated polymer electrolyte membrane for use in an electrochemical fuel cell produced according to the method of claim 1.

9. An electrochemical fuel cell comprising a sulfonated polymer electrolyte membrane produced according to the method of claim 1.
